(19) United States
(12) Patent Application Publication
(10) Pub. No.: US 2022/0277578 A1
(43) Pub. Date: Sep. 1, 2022

(54) INFORMATION OUTPUT APPARATUS, INFORMATION OUTPUT METHOD, AND PROGRAM

(71) Applicant: NEC Corporation, Tokyo (JP)

(72) Inventors: Tomoko NISHIO, Tokyo (JP); Akira Kamei, Tokyo (JP); Kenichiro Ida, Tokyo (JP); Itsumi Kato, Tokyo (JP); Tomotaka Suzuki, Tokyo (JP)

(73) Assignee: NEC Corporation, Tokyo (JP)

(21) Appl. No.: 17/677,086

(22) Filed: Feb. 22, 2022

(30) Foreign Application Priority Data
Mar. 1, 2021 (JP) 2021-013451

(51) Int. Cl. G06V 40/10; G06T 7/62; G06T 11/20; G06T 11/60

(52) U.S. Cl. CPC G06V 40/10; G06T 7/62; G06T 11/203; G06T 11/60

(57) ABSTRACT

To make it easy to recognize whether each person is in a situation in which the person may catch an infectious disease, the present invention provides an information output apparatus 10 including an acquisition unit 11 that acquires a captured image acquired by photographing a space, a detection unit 12 that detects a person from the captured image, a determination unit 13 that determines a radius of a circle to be displayed over the captured image in an overlapping manner according to a predetermined condition, and a display control unit 15 that displays an image in which a circle surrounding each of the detected persons is displayed over the captured image in an overlapping manner.

### TECHNICAL FIELD

The present invention relates to an information output apparatus, an information output method, and a program.

### BACKGROUND ART

In recent years, image processing has been employed for various purposes. For example, Patent Document 1 describes a system configured in such a way that a reach range of splash from a first target person is deviated from a breathing area of a second target person by adjusting an environment in a space, wherein a position and an orientation of a face of each of the first target person and the second target person are determined by image processing.

### RELATED DOCUMENT

### Patent Document

[Patent Document 1] International Publication No. WO2020/044826

### DISCLOSURE OF THE INVENTION

### Technical Problem

In order to reduce a risk of catching an infectious disease, it is important to avoid a situation in which a person may catch an infectious disease. However, it is difficult to recognize whether each person is in a situation in which the person may catch an infectious disease. One of objects of the present invention is to make it easy to recognize whether each person is in a situation in which the person may catch an infectious disease.

### Solution to Problem

The present invention provides an information output apparatus including:

an acquisition means for acquiring a captured image acquired by photographing a space;

a detection means for detecting a person from the captured image;

a determination means for determining a radius of a circle to be displayed over the captured image in an overlapping manner according to a predetermined condition; and

a display control means for displaying an image in which a circle surrounding each of the detected persons is displayed over the captured image in an overlapping manner.

Further, the present invention provides an information output method including:

by a computer,

acquiring a captured image acquired by photographing a space;

detecting a person from the captured image;

determining a radius of a circle to be displayed over the captured image in an overlapping manner according to a predetermined condition; and

displaying an image in which a circle surrounding each of the detected persons is displayed over the captured image in an overlapping manner.

Further, the present invention provides a program causing a computer to function as:

an acquisition means for acquiring a captured image acquired by photographing a space;

a detection means for detecting a person from the captured image;

a determination means for determining a radius of a circle to be displayed over the captured image in an overlapping manner according to a predetermined condition; and

a display control means for displaying an image in which a circle surrounding each of the detected persons is displayed over the captured image in an overlapping manner.

### Advantageous Effects of the Invention

According to the present invention, it becomes easy to recognize whether each person is in a situation in which the person may catch an infectious disease.

### BRIEF DESCRIPTION OF THE DRAWINGS

FIG. 1 is a diagram illustrating one example of a screen to be provided by an information output apparatus according to the present example embodiment.

FIG. 2 is a diagram illustrating one example of a screen to be provided by the information output apparatus according to the present example embodiment.

FIG. 3 is a diagram illustrating one example of a hardware configuration of the information output apparatus according to the present example embodiment.

FIG. 4 is one example of a functional block diagram of the information output apparatus according to the present example embodiment.

FIG. 5 is a flowchart illustrating one example of a flow of processing of the information output apparatus according to the present example embodiment.

FIG. 6 is a diagram illustrating one example of an imaging apparatus according to the present example embodiment.

FIG. 7 is a diagram illustrating one example of information to be provided by the information output apparatus according to the present example embodiment.

FIG. 8 is a diagram illustrating processing of the information output apparatus according to the present example embodiment.

FIG. 9 is a flowchart illustrating one example of a flow of processing of the information output apparatus according to the present example embodiment.

FIG. 10 is a diagram illustrating processing of the information output apparatus according to the present example embodiment.

FIG. 11 is a flowchart illustrating one example of a flow of processing of the information output apparatus according to the present example embodiment.

FIG. 12 is a diagram illustrating processing of the information output apparatus according to the present example embodiment.

FIG. 13 is a flowchart illustrating one example of a flow of processing of the information output apparatus according to the present example embodiment.

FIG. 14 is a flowchart illustrating one example of a flow of processing of the information output apparatus according to the present example embodiment.

FIG. 15 is a flowchart illustrating one example of a flow of processing of the information output apparatus according to the present example embodiment.

### DESCRIPTION OF EMBODIMENTS

In the following, example embodiments according to the present invention are described by using the drawings. Note that, in every drawing, a similar component is designated with a similar reference sign, and description thereof is omitted as necessary.

### First Example Embodiment

### “Overview”

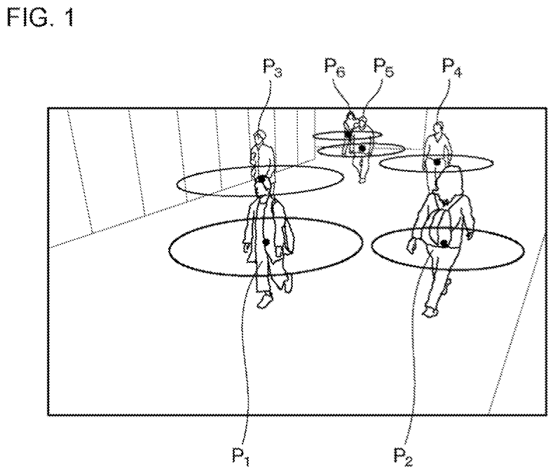

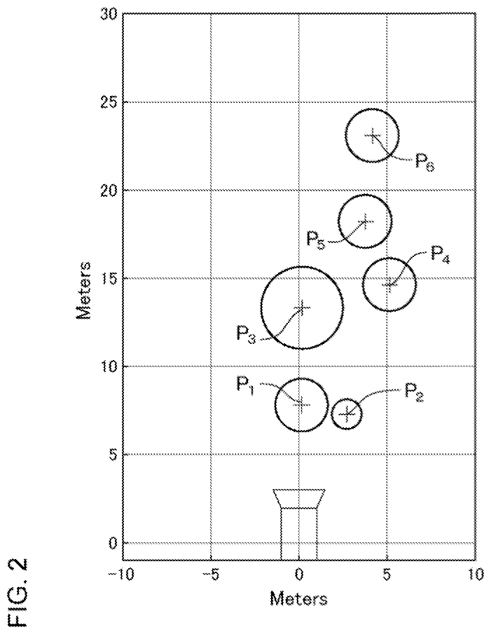

When acquiring a captured image acquired by photographing a space, an information output apparatus analyzes the captured image, and generates and outputs a circular display image as illustrated in FIG. 1 or FIG. 2. As will be described later in detail, the circular display image in FIG. 1 is an image in which a circle is displayed over a captured image in an overlapping manner in such a way as to surround a position of each of persons detected within the captured image. The circular display image in FIG. 2 is an image in which a circle is displayed, in a plan view (P₁ to P₆ are positions of persons) illustrating a position of a detected person, in an overlapping manner in such a way as to surround a position of each of persons detected within a captured image. It is possible to recognize whether a distance between persons is in a preferable state from an aspect of infection prevention by presence or absence of overlapping of a circle, or the like.

The information output apparatus has a feature that a radius of a circle to be displayed on the above-described circular display image is determined based on at least either one of “a state of a space at a time of generating a captured image”, and “a state of each person at a time of generating a captured image”. Specifically, a size of a circle illustrated in FIG. 1 or FIG. 2 changes according to a state of a space or a state of each person at a time of generating a captured image.

A risk of infection may change according to a state of a space (e.g., a temperature, humidity, an amount of ultraviolet rays, and the like), or a state of each person (e.g., a height, presence or absence of a disease, an age, a body temperature, and the like) at that occasion. In the information output apparatus according to the present example embodiment in which a radius of a circle to be displayed on the above-described circular display image is determined based on at least either one of “a state of a space at a time of generating a captured image”, and “a state of each person at a time of generating a captured image”, it becomes possible to accurately recognize whether each person is in a situation in which the person may catch an infectious disease, taking into consideration various states at that occasion.

### “Hardware Configuration”

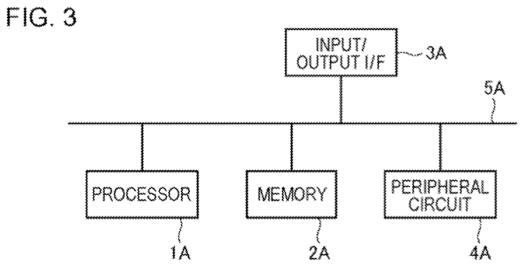

Next, one example of a hardware configuration of the information output apparatus is described. FIG. 3 is a diagram illustrating a hardware configuration example of the information output apparatus. Each functional unit included in the information output apparatus is achieved by any combination of hardware and software, mainly including a central processing unit (CPU) of any computer, a memory, a program loaded in a memory, a storage unit (capable of storing, in addition to a program stored in advance at a shipping stage of an apparatus, a program downloaded from a storage medium such as a compact disc (CD), a server on the Internet, and the like) such as a hard disk storing the program, and an interface for network connection. It is understood by a person skilled in the art that there are various modification examples as a method and an apparatus for achieving the configuration.

As illustrated in FIG. 3, the information output apparatus includes a processor 1A, a memory 2A, an input/output interface 3A, a peripheral circuit 4A, and a bus 5A. The peripheral circuit 4A includes various modules. The information output apparatus may not include the peripheral circuit 4A. Note that, the information output apparatus may be configured by a plurality of apparatuses that are physically and/or logically separated, or may be configured by one apparatus that is physically and/or logically integrated. In the former case, each of the plurality of apparatuses constituting the information output apparatus can include the above-described hardware configuration.

The bus 5A is a data transmission path along which the processor 1A, the memory 2A, the peripheral circuit 4A, and the input/output interface 3A mutually transmit and receive data. The processor 1A is, for example, an arithmetic processing apparatus such as a CPU and a graphics processing unit (GPU). The memory 2A is, for example, a memory such as a random access memory (RAM) and a read only memory (ROM). The input/output interface 3A includes an interface for acquiring information from an input apparatus, an external apparatus, an external server, an external sensor, and the like, an interface for outputting information to an output apparatus, an external apparatus, an external server, and the like, and the like. The input apparatus is, for example, a keyboard, a mouse, a microphone, and the like. The output apparatus is, for example, a display, a speaker, a printer, a mailer, and the like. The processor 1A can issue a command to each module, and perform an arithmetic operation, based on an arithmetic operation result of each module.

### “Functional Configuration”

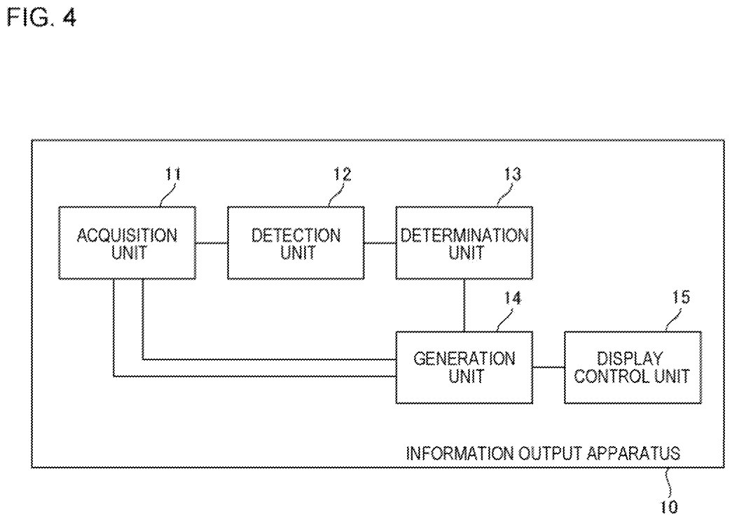

Next, a functional configuration of the information output apparatus is described. FIG. 4 illustrates one example of a functional block diagram of an information output apparatus 10. As illustrated in FIG. 4, the information output apparatus 10 includes an acquisition unit 11, a detection unit 12, a determination unit 13, a generation unit 14, and a display control unit 15.

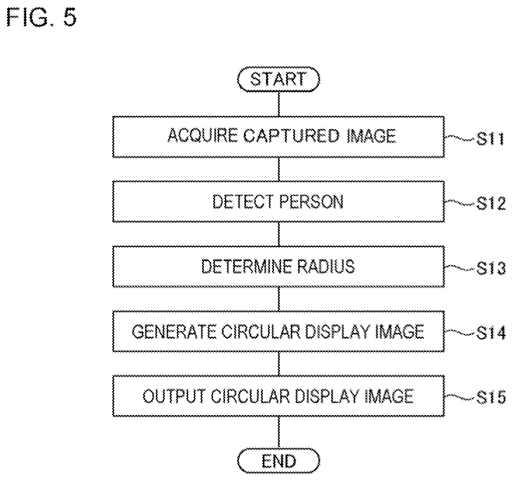

Processing illustrated in a flowchart in FIG. 5 is performed by these functional units. In the following, each processing, and a configuration of a functional unit that performs each processing are described in an order illustrated in the flowchart in FIG. 5.

### —Acquire Captured Image (S11)—

In S11, the acquisition unit 11 acquires a captured image acquired by photographing a space.

A space to be captured is a space where a person may be present. For example, a space on a street, a space within a facility, and the like are exemplified, but the space is not limited thereto.

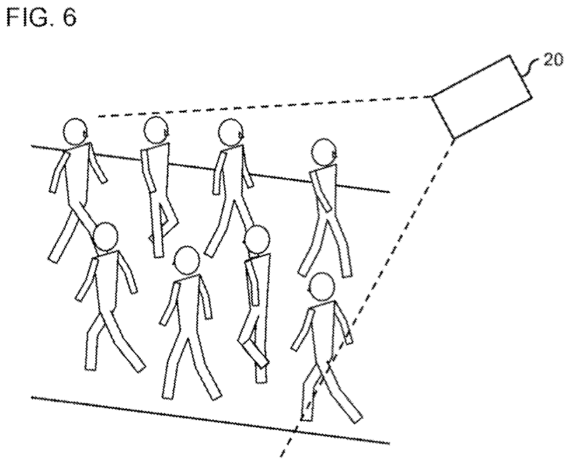

A captured image is generated by an imaging apparatus 20. A captured image may be a video, namely a moving image, or a photo, namely a still image The imaging apparatus 20 is, for example, a surveillance camera installed at any position on a street or within a facility. As illustrated in FIG. 6, the imaging apparatus 20 is installed at a position and in an orientation where a person present within a space is captured.

In addition to the above, the imaging apparatus 20 may be a camera installed on a moving body such as an automobile, a bicycle, and a flying object, and configured to photograph various spaces while moving. At this occasion, the imaging apparatus 20 is also installed on the moving body at a position and in an orientation where a person present within a space is captured.

In addition to the above, the imaging apparatus 20 may be a camera carried by a person (also including a video camera and a mobile terminal equipped with a camera function such as a smartphone, a tablet terminal, and a mobile phone).

The acquisition unit 11 may acquire a captured image generated by the imaging apparatus 20 by real-time processing, or may acquire by batch processing. A means for inputting a captured image generated by the imaging apparatus 20 to the information output apparatus 10 by real-time processing or batch processing can be achieved by using any available technique.

### —Detect Person (S12)—

In S12, the detection unit 12 detects a person from a captured image. The detection unit 12 can achieve detection of the person by using any available technique.

### —Determine Radius (S13)—

In S13, the determination unit 13 determines a radius of a circle to be displayed on a circular display image according to a predetermined condition. For example, the determination unit 13 determines a radius of a circle to be displayed on a circular display image, based on at least either one of a state of a space at a time of generating a captured image, and a state of each person detected from a captured image.

A state of a space at a time of generating a captured image is defined by an item that may affect a risk of infection. As such an item, for example, a temperature, humidity, an amount of ultraviolet rays, and the like are exemplified, but the item is not limited thereto. The determination unit 13 may acquire actual measurement values of these items by various sensors installed in a space, and recognize a state of the space, based on the actual measurement values. In addition to the above, the determination unit 13 may acquire, from various servers, predicted values or actual measurement values of these items, and recognize a state of the space, based on the predicted values or the actual measurement values.

The determination unit 13 determines a radius according to a recognized state of a space, based on “information indicating a relation between a state of a space and a value of a radius” (such as a table and an arithmetic formula) being held in advance. Note that, the information is defined in such a way that a large radius is determined, as a risk of infection (a risk of infecting another person, a risk at which a person is infected by another person) increases, and a small radius is determined, as a risk of infection decreases.

Further, a state of each person detected from a captured image is defined by an item that may affect a risk of infection. As such an item, for example, a height, presence or absence of a disease, an age, a body temperature, and the like are exemplified, but the item is not limited thereto. The determination unit 13 may analyze a captured image, or an actual measurement value by another sensor installed in a space, and determine a state of these items for each detected person.

Then, the determination unit 13 determines a radius according to a recognized state of each person, for each person, based on “information indicating a relation between a state of a person and a value of a radius” (such as a table and an arithmetic formula) being held in advance. Note that, the information is defined in such a way that a large radius is determined, as a risk of infection (a risk of infecting another person, a risk at which a person is infected by another person) increases, and a small radius is determined, as a risk of infection decreases.

Note that, in the following example embodiments, a specific example of processing of determining the radius is described.

### —Generate Circular Display Image (S14)—

In S14, the generation unit 14 generates a circular display image in which a circle whose radius has a value determined by the determination unit 13, and which surrounds a position of each of detected persons is displayed on an image indicating a position of each of detected persons.

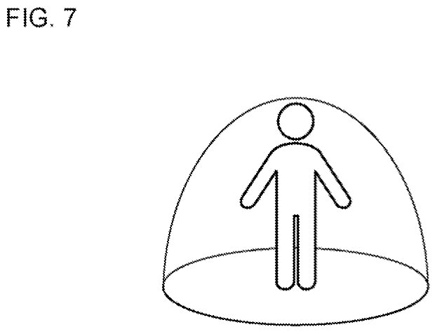

FIG. 1 illustrates one example of the circular display image. The illustrated circular display image is an image in which a circle is displayed over a captured image in an overlapping manner in such a way as to surround a position of each of persons detected within the captured image. In the illustrated example, six persons P₁ to P₆ are detected within the captured image. Then, a center of a circle surrounding each person is aligned with a position of each person. The circle is substantially in parallel to the ground. Note that, in the illustrated example, a circle is displayed near a position of a waist of a person, but may be displayed at a foot of a person, may be displayed near a face of a person, or may be displayed at another position. Further, as illustrated in FIG. 7, a hemisphere including a circle as a part thereof may be displayed in such a way as to enclose each person.

FIG. 2 illustrates another example of the circular display image. The illustrated circular display image is an image in which a circle is displayed, in a plan view indicating a position of a detected person, in an overlapping manner in such a way as to surround a position of each of persons detected within a captured image. In the illustrated example, positions of the six persons P₁ to P₆ are indicated. Further, a center of a circle surrounding a position of each person is aligned with a position of each person. In addition, in the illustrated example, it becomes easy to recognize a distance between persons by displaying a scale of length on a vertical axis and a horizontal axis.

When a radius of a circle to be displayed on a circular display image is determined based on a state of a space at a time of generating a captured image, a radius (size) of a circle illustrated in FIG. 1 or FIG. 2 may change according to a state of a space at that occasion. Further, when a radius of a circle to be displayed on a circular display image is determined for each person, based on a state of each person detected from a captured image, as illustrated in FIG. 1 or FIG. 2, a radius (size) of a circle to be displayed may differ for each person. In addition, a radius (size) of a circle surrounding each person may change according to a state of each person at that occasion.

### —Output Circular Display Image (S15)—

In S15, the display control unit 15 transmits/inputs, to a display apparatus, a circular display image generated by the generation unit 14, and causes the display apparatus to display the circular display image. As the display apparatus, a display, a projection apparatus, a smartphone, a tablet terminal, a mobile phone, a personal computer, and the like are exemplified, but the display apparatus is not limited thereto.

### “Advantageous Effect”

When acquiring a captured image acquired by photographing a space, the information output apparatus 10 according to the present example embodiment can analyze the captured image, and generate and output a circular display image as illustrated in FIG. 1 or FIG. 2. It is possible to recognize whether a distance between persons is in a preferable state from an aspect of infection prevention by presence or absence of overlapping of a circle, or the like.

Then, the information output apparatus 10 determines a radius of a circle to be displayed on the above-described circular display image, based on at least either one of “a state of a space at a time of generating a captured image”, and “a state of each person at a time of generating a captured image”. Specifically, a large radius is determined, as a risk of infection (a risk of infecting another person, a risk at which a person is infected by another person) increases, and a small radius is determined, as a risk of infection decreases. According to the information output apparatus 10 as described above, it becomes possible to accurately recognize whether each person is in a situation in which the person may catch an infectious disease, taking into consideration various states at that occasion.

### Second Example Embodiment

An information output apparatus 10 according to the present example embodiment determines a radius of a circle to be displayed on a circular display image, based on at least one of a temperature, humidity, and an amount of ultraviolet rays of a space at a time of generating a captured image. In the following, the information output apparatus 10 is described in detail.

A determination unit 13 determines a radius of a circle to be displayed on a circular display image, based on at least one of a temperature, humidity, and an amount of ultraviolet rays of a space at a time of generating a captured image.

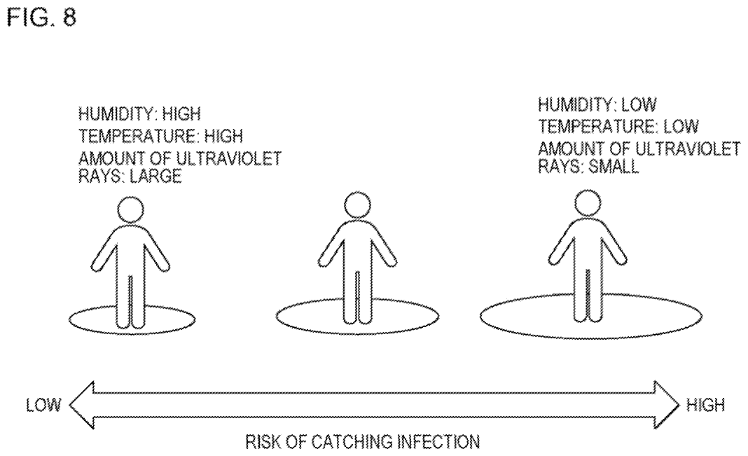

As illustrated in FIG. 8, it is known that a risk of infection concerning an infectious disease increases, as a temperature decreases, as humidity decreases, and as an amount of ultraviolet rays decreases. In view of the above, regarding “information indicating a relation between a state of a space and a value of a radius” described in the first example embodiment, it is defined in such a way that a large radius is determined, as a temperature decreases, as humidity decreases, and an amount of ultraviolet rays decreases, and a small radius is determined, as a temperature increases, as humidity increases, and an amount of ultraviolet rays increases.

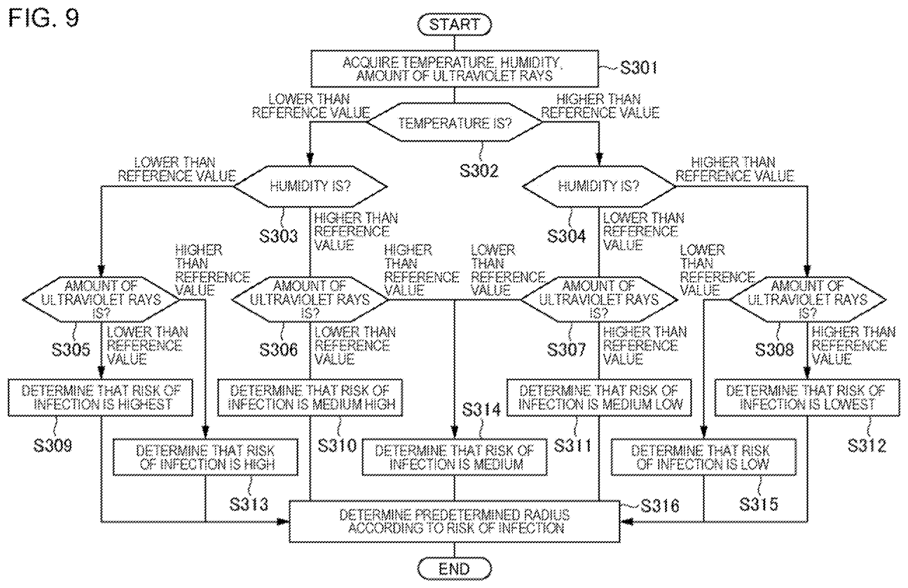

FIG. 9 illustrates one example of processing by the determination unit 13. In the illustrated example, the determination unit 13 determines whether each of a temperature, humidity, and an amount of ultraviolet rays is higher than a reference value (S302 to S308), and classifies risks of infection into “highest”, “high”, “medium high”, “medium”, “medium low”, “low”, and “lowest”, based on results of the determination (S309 to S315). Then, the determination unit 13 determines a radius of a circle to be displayed on a circular display image, based on the classified risk of infection (S316). As a risk of infection increases, a large radius is determined.

Note that, in the illustrated example, it is determined whether each of the values is higher than the reference value in an order of a temperature, humidity, and an amount of ultraviolet rays of a space. As a modification example, the determination may be performed in another order.

Further, in the illustrated example, a radius of a circle to be displayed on a circular display image is determined based on all of a temperature, humidity, and an amount of ultraviolet rays of a space. As a modification example, a radius of a circle to be displayed on a circular display image may be determined by similar processing, based on a part of a temperature, humidity, and an amount of ultraviolet rays of a space.

Further, in the illustrated example, each of a temperature, humidity, and an amount of ultraviolet rays is classified into two states (“a state in which a value is higher than the reference value”, and “a state in which a value is lower than the reference value”), based on a value thereof, and a risk of infection is determined based on a result of these classifications. As a modification example, each of a temperature, humidity, and an amount of ultraviolet rays may be classified into three or more states, and a risk of infection may be determined based on a result of these classifications.

Further, in the illustrated example, each of a temperature, humidity, and an amount of ultraviolet rays is classified into two states (“a state in which a value is higher than the reference value”, and “a state in which a value is lower than the reference value”), based on a value thereof, a risk of infection is determined based on a result of these classifications, and then, a radius of a circle to be displayed on a circular display image is determined based on the determined risk of infection. As a modification example, each of a temperature, humidity, and an amount of ultraviolet rays may be classified into two states (“a state in which a value is higher than the reference value”, and “a state in which a value is lower than the reference value”), based on a value thereof, and a radius of a circle to be displayed on a circular display image may be determined based on a result of these classifications. Specifically, a radius of a circle to be displayed on a circular display image may be determined from the above-described classification result, without performing determination on a risk of infection.

Other configuration of the information output apparatus 10 according to the present example embodiment is similar to that of the first example embodiment.

As described above, in the information output apparatus 10 according to the present example embodiment, an advantageous effect similar to that of the first example embodiment is achieved. Further, in the information output apparatus 10 according to the present example embodiment, it is possible to determine a radius of a circle to be displayed on a circular display image, based on at least one of a temperature, humidity, and an amount of ultraviolet rays of a space at a time of generating a captured image. According to the information output apparatus 10 as described above, it becomes possible to accurately recognize whether each person is in a situation in which the person may catch an infectious disease, taking into consideration a state of a space at that occasion.

### Third Example Embodiment

An information output apparatus 10 according to the present example embodiment determines a radius of a circle to be displayed on a circular display image, based on a height of each person at a time of generating a captured image. In the following, the information output apparatus 10 is described in detail.

A determination unit 13 determines a height of each person detected from a captured image, based on the captured image. Then, the determination unit 13 determines a radius of a circle to be displayed on a circular display image, based on the determined height of each person.

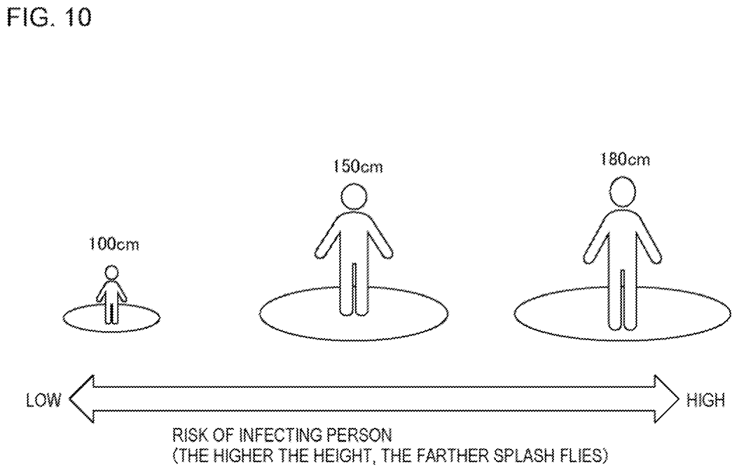

As illustrated in FIG. 10, it is known that, as a height of a person increases, a risk of infecting another person increases, since the higher the height of the person, the farther splash flies. In view of the above, regarding “information indicating a relation between a state of a person and a value of a radius” described in the first example embodiment, it is defined in such a way that a large radius is determined, as a height of a person increases, and a small radius is determined, as a height of a person decreases.

Processing of determining a height of a person by an image analysis can be achieved by any available technique. For example, in a case where an imaging apparatus 20 is a surveillance camera installed at any position on a street or within a facility, any object (such as a mailbox, a bending machine, or a traffic light) installed within a photographing area is always present within a captured image. An actual height of the object may be measured in advance, and input to the information output apparatus 10. Then, the information output apparatus 10 may estimate a height of each person, based on a relative positional relation among each person detected within a captured image and the object, a height of the object within the image, and an actual height of the object.

In addition to the above, a feature value of an external appearance and a height of each of a plurality of persons may be registered in advance in a database. Then, the determination unit 13 may recognize a person detected by collating a feature value of an external appearance of a person detected from the captured image with a feature value of an external appearance registered in the database, and acquire a height of the recognized person from the database.

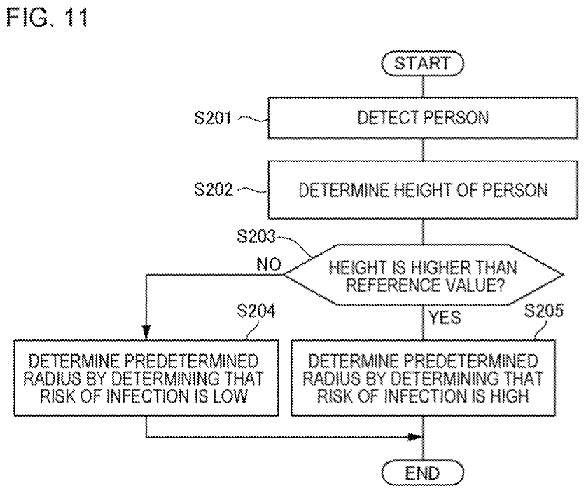

FIG. 11 illustrates one example of processing by a detection unit 12 and the determination unit 13. In the illustrated example, after the detection unit 12 detects a person from a captured image (S201), the determination unit 13 determines a height of each of the detected persons (S202). Then, when the height is higher than a reference value (YES in S203), it is determined that a risk of infection is high, and a radius of a circle according to a result of the determination is determined (S205). On the other hand, when the height is equal to or lower than the reference value (NO in S203), it is determined that a risk of infection is low, and a radius of a circle according to a result of the determination is determined (S204). As a risk of infection increases, a large radius is determined.

Note that, in the illustrated example, a height is classified into two states (“a state in which a height is higher than the reference value”, and “a state in which a height is equal to or lower than the reference value”), based on a value thereof, and a risk of infection is determined based on a result of these classifications. As a modification example, a height may be classified into three or more states, and a risk of infection may be determined based on a result of these classifications.

Further, in the illustrated example, a height is classified into two states (“a state in which a height is higher than a reference value”, and “a state in which a height is equal to or lower than the reference value”), based on a value thereof, a risk of infection is determined based on a result of these classifications, and then, a radius of a circle to be displayed on a circular display image is determined based on the determined risk of infection. As a modification example, a height may be classified into two states (“a state in which a height is higher than the reference value”, and “a state in which a height is equal to or lower than the reference value”), based on a value thereof, and a radius of a circle to be displayed on a circular display image may be determined based on a result of these classifications. Specifically, a radius of a circle to be displayed on a circular display image may be determined from the above-described classification result, without performing determination on a risk of infection.

Other configuration of the information output apparatus 10 according to the present example embodiment is similar to that of the first and second example embodiments.

As described above, in the information output apparatus 10 according to the present example embodiment, an advantageous effect similar to that of the first and second example embodiments is achieved. Further, in the information output apparatus 10 according to the present example embodiment, it is possible to determine a radius of a circle to be displayed on a circular display image for each person, based on a height of each person detected from a captured image. According to the information output apparatus 10 as described above, it becomes possible to accurately recognize whether each person is in a situation in which the person may catch an infectious disease, taking into consideration a height of each of persons present within a captured image.

### Fourth Example Embodiment

An information output apparatus 10 according to the present example embodiment determines a radius of a circle to be displayed on a circular display image, based on presence or absence of a disease of each person at a time of generating a captured image. In the following, the information output apparatus 10 is described in detail.

A determination unit 13 determines presence or absence of a disease of each person detected from a captured image, based on the captured image. Then, the determination unit 13 determines a radius of a circle to be displayed on a circular display image, based on the determined presence or absence of a disease of each person.

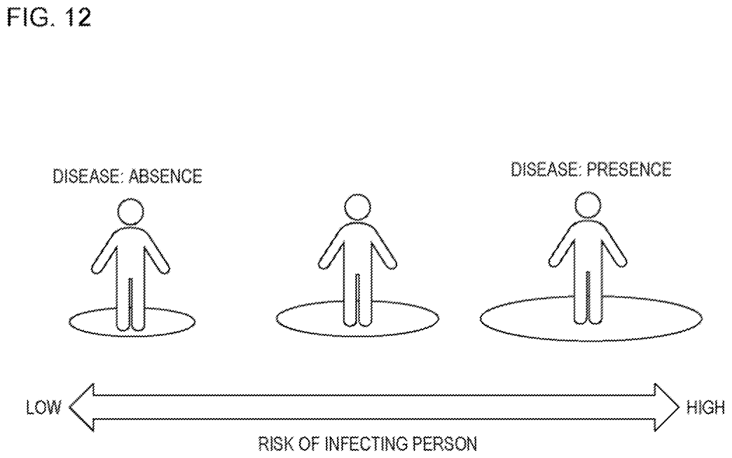

As illustrated in FIG. 12, it is known that a risk of infecting another person increases, when a person has a disease, and often coughs and sneezes. In view of the above, regarding “information indicating a relation between a state of a person and a value of a radius” described in the first example embodiment, it is defined in such a way that a relatively large radius is determined for a person having a disease, and a relatively small radius is determined for a person having no disease.

Processing of determining presence or absence of a disease of a person by an image analysis can be achieved by using any available technique. For example, the determination unit 13 may extract a joint point of a person by analyzing a captured image (preferably, a moving image), and estimate a pose of the person, based on a result of the extraction. Then, the determination unit 13 may determine that a person in which a pose at a time of coughing or sneezing is detected has a disease. Extraction of a joint point can be achieved by using any available technique such as an OpenPose.

In addition to the above, a feature value of an external appearance and presence or absence of a disease of each of a plurality of persons may be registered in advance in a database. Then, the determination unit 13 may recognize a person detected by collating a feature value of an external appearance of a person detected from a captured image with a feature value of an external appearance registered in the database, and acquire information indicating presence or absence of a disease of the recognized person from the database.

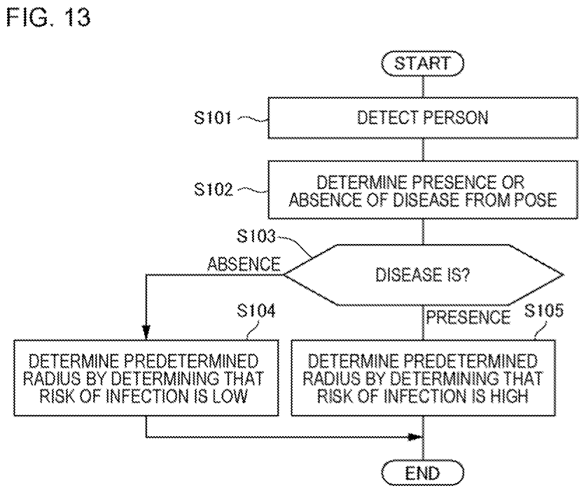

FIG. 13 illustrates one example of processing by a detection unit 12 and the determination unit 13. In the illustrated example, after the detection unit 12 detects a person from a captured image (S101), the determination unit 13 determines presence or absence of a disease of each of the detected persons (S102). Then, when the person has a disease (PRESENCE in S103), it is determined that a risk of infection is high, and a radius of a circle according to a result of the determination is determined (S105). On the other hand, when the person does not have a disease (ABSENCE in S103), it is determined that a risk of infection is low, and a radius of a circle according to a result of the determination is determined (S104). As a risk of infection increases, a large radius is determined.

Note that, in the illustrated example, a risk of infection is determined based on a determination result on presence or absence of a disease, and then, a radius of a circle to be displayed on a circular display image is determined based on the determined risk of infection. As a modification example, a radius of a circle to be displayed on a circular display image may be determined based on a determination result on presence or absence of a disease. Specifically, a radius of a circle to be displayed on a circular display image may be determined from the above-described determination result on presence or absence of a disease, without performing determination on a risk of infection.

Other configuration of the information output apparatus 10 according to the present example embodiment is similar to that of the first to third example embodiments.

As described above, in the information output apparatus 10 according to the present example embodiment, an advantageous effect similar to that of the first to third example embodiments is achieved. Further, in the information output apparatus 10 according to the present example embodiment, it is possible to determine a radius of a circle to be displayed on a circular display image for each person, based on presence or absence of a disease of each person detected from a captured image. According to the information output apparatus 10 as described above, it becomes possible to accurately recognize whether each person is in a situation in which the person may catch an infectious disease, taking into consideration presence or absence of a disease of each person at that occasion.

### Fifth Example Embodiment

An information output apparatus 10 according to the present example embodiment determines a radius of a circle to be displayed on a circular display image, based on an age of each person at a time of generating a captured image. In the following, the information output apparatus 10 is described in detail.

A determination unit 13 determines an age of each person detected from a captured image, based on the captured image. Then, the determination unit 13 determines a radius of a circle to be displayed on a circular display image, based on the determined age of each person.

It is known that, as an age increases, a body is weakened, and a risk of infection increases. In view of the above, regarding “information indicating a relation between a state of a person and a value of a radius” described in the first example embodiment, it is defined in such a way that a large radius is determined, when an age is higher than a reference value, and a small radius is determined, when an age is equal to or lower than the reference value.

Processing of determining an age of a person by an image analysis can be achieved by using any available technique. For example, the determination unit 13 may estimate an age of a person, based on a feature (a position of a part such as an eye, a nose, and a mouth, a degree of wrinkles, and the like) of a face of each person included in a captured image.

In addition to the above, a feature value of an external appearance and an age of each of a plurality of persons may be registered in advance in a database. Then, the determination unit 13 may recognize a person detected by collating a feature value of an external appearance of a person detected from the captured image with a feature value of an external appearance registered in the database, and acquire an age of the recognized person from the database.

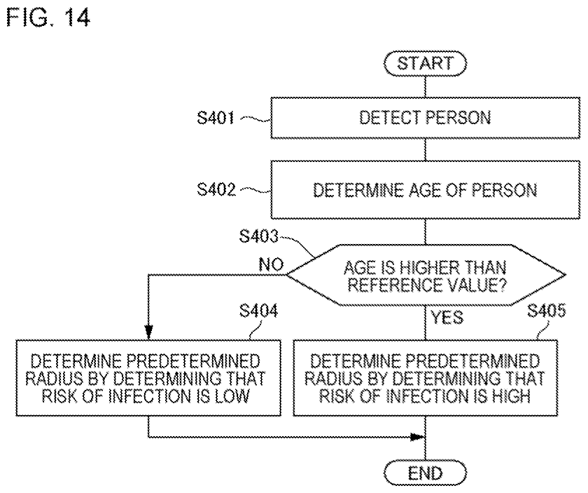

FIG. 14 illustrates one example of processing by a detection unit 12 and the determination unit 13. In the illustrated example, after the detection unit 12 detects a person from a captured image (S401), the determination unit 13 determines an age of each of the detected persons (S402). Then, when the age is higher than a reference value (example: 65 years old, 70 years old, and the like) (YES in S403), it is determined that a risk of infection is high, and a radius of a circle according to a result of the determination is determined (S405). On the other hand, when the age is equal to or lower than the reference value (NO in S403), it is determined that a risk of infection is low, and a radius of a circle according to a result of the determination is determined (S404). As a risk of infection increases, a large radius is determined.

Note that, in the illustrated example, an age is classified into two states (“a state in which an age is higher than the reference value”, and “a state in which an age is equal to or lower than the reference value”), based on a value thereof, and a risk of infection is determined based on a result of these classifications. As a modification example, an age may be classified into three or more states, and a risk of infection may be determined based on a result of these classifications.

Further, in the illustrated example, an age is classified into two states (“a state in which an age is higher than the reference value”, and “a state in which an age is equal to or lower than the reference value”), based on a value thereof, a risk of infection is determined based on a result of these classifications, and then, a radius of a circle to be displayed on a circular display image is determined based on the determined risk of infection. As a modification example, an age may be classified into two states (“a state in which an age is higher than the reference value”, and “a state in which an age is equal to or lower than the reference value”), based on a value thereof, and a radius of a circle to be displayed on a circular display image may be determined based on a result of these classifications. Specifically, a radius of a circle to be displayed on a circular display image may be determined from the above-described classification result, without performing determination on a risk of infection.

Other configuration of the information output apparatus 10 according to the present example embodiment is similar to that of the first to fourth example embodiments.

As described above, in the information output apparatus 10 according to the present example embodiment, an advantageous effect similar to that of the first to fourth example embodiments is achieved. Further, in the information output apparatus 10 according to the present example embodiment, it is possible to determine a radius of a circle to be displayed on a circular display image for each person, based on an age of each person detected from a captured image. According to the information output apparatus 10 as described above, it becomes possible to accurately recognize whether each person is in a situation in which the person may catch an infectious disease, taking into consideration an age of each of persons present within a captured image.

### Sixth Example Embodiment

An information output apparatus 10 according to the present example embodiment determines a radius of a circle to be displayed on a circular display image, based on a body temperature of each person at a time of generating a captured image. In the following, the information processing apparatus 10 is described in detail.

A determination unit 13 determines a body temperature of each person detected from a captured image, based on the captured image. Then, the determination unit 13 determines a radius of a circle to be displayed on a circular display image, based on the determined body temperature of each person.

When a body temperature is higher than a reference value (example: 37° C.), there is a possibility that the person is infected with an infectious disease. In view of the above, regarding “information indicating a relation between a state of a person and a value of a radius” described in the first example embodiment, it is defined in such a way that a large radius is determined when a body temperature is higher than the reference value, and a small radius is determined when a body temperature is equal to or lower than the reference value.

Processing of determining a body temperature of a person can be achieved by using any available technique. For example, a body temperature of each person may be determined based on a thermal image generated by an infrared camera.

In addition to the above, a feature value of an external appearance and a body temperature measured on that day of each of a plurality of persons may be registered in advance in a database. Then, the determination unit 13 may recognize a person detected by collating a feature value of an external appearance of a person detected from a captured image with a feature value of an external appearance registered in the database, and acquire a body temperature of the recognized person from the database.

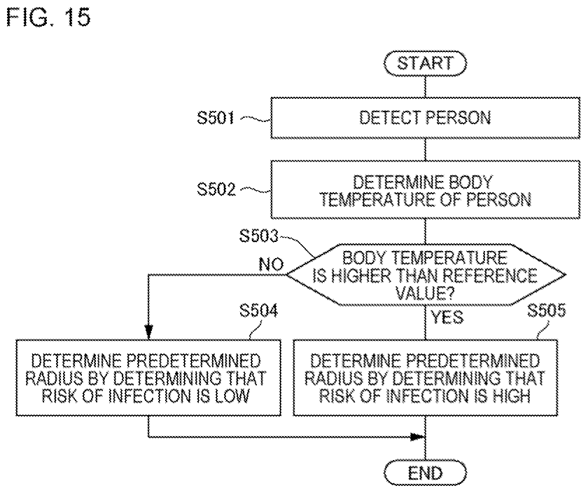

FIG. 15 illustrates one example of processing by a detection unit 12 and the determination unit 13. In the illustrated example, after the detection unit 12 detects a person from a captured image (S501), the determination unit 13 determines a body temperature of each of the detected persons (S502). Then, when a body temperature is higher than the reference value (example: 37° C.) (YES in S503), it is determined that a risk of infection is high, and a radius of a circle according to a result of the determination is determined (S505). On the other hand, when a body temperature is equal to or lower than the reference value (NO in S503), it is determined that a risk of infection is low, and a radius of a circle according to a result of the determination is determined (S504). As a risk of infection increases, a large radius is determined.

Note that, in the illustrated example, a body temperature is classified into two states (“a state in which a body temperature is higher than the reference value”, and “a state in which a body temperature is equal to or lower than the reference value”), based on a value thereof, and a risk of infection is determined based on a result of these classifications. As a modification example, a body temperature may be classified into three or more states, and a risk of infection may be determined based on a result of these classifications.

Further, in the illustrated example, a body temperature is classified into two states (“a state in which a body temperature is higher than the reference value”, and “a state in which a body temperature is equal to or lower than the reference value”), based on a value thereof, a risk of infection is determined based on a result of these classifications, and then, a radius of a circle to be displayed on a circular display image is determined based on the determined risk of infection. As a modification example, a body temperature may be classified into two states (“a state in which a body temperature is higher than the reference value”, and “a state in which a body temperature is equal to or lower than the reference value”), based on a value thereof, and a radius of a circle to be displayed on a circular display image may be determined based on a result of these classifications. Specifically, a radius of a circle to be displayed on a circular display image may be determined from the above-described classification result, without performing determination on a risk of infection.

Other configuration of the information output apparatus 10 according to the present example embodiment is similar to that of the first to fifth example embodiments.

As described above, in the information output apparatus 10 according to the present example embodiment, an advantageous effect similar to that of the first to fifth example embodiments is achieved. Further, in the information output apparatus 10 according to the present example embodiment, it is possible to determine a radius of a circle to be displayed on a circular display image for each person, based on a body temperature of each person detected from a captured image. According to the information output apparatus 10 as described above, it becomes possible to accurately recognize whether each person is in a situation in which the person may catch an infectious disease, taking into consideration a body temperature of each person at that occasion.

Note that, in the present specification, “acquisition” includes at least one of “fetching data stored in another apparatus or a storage medium by an own apparatus (active acquisition)”, based on a user input, or based on a command of a program, for example, requesting or inquiring another apparatus and receiving, accessing to another apparatus or a storage medium and reading, and the like, “inputting data to be output from another apparatus to an own apparatus (passive acquisition)”, based on a user input, or based on a command of a program, for example, receiving data to be distributed (or transmitted, push-notified, or the like), and acquiring by selecting from among received data or information, and “generating new data by editing data (such as converting into a text, rearranging data, extracting a part of pieces of data, and changing a file format) and the like, and acquiring the new data”.

A part or all of the above-described example embodiments may also be described as the following supplementary notes, but is not limited to the following.

1. An information output apparatus including:

an acquisition means for acquiring a captured image acquired by photographing a space;

a detection means for detecting a person from the captured image;

a determination means for determining a radius of a circle to be displayed over the captured image in an overlapping manner according to a predetermined condition; and

a display control means for displaying an image in which a circle surrounding each of the detected persons is displayed over the captured image in an overlapping manner.

2. The information output apparatus according to supplementary note 1, wherein

the determination means determines a radius of a circle to be displayed over the captured image in an overlapping manner, based on a state of the space at a time of generating the captured image.

3. The information output apparatus according to supplementary note 2, wherein

the determination means determines a radius of a circle to be displayed over the captured image in an overlapping manner, based on at least one of a temperature, humidity, and an amount of ultraviolet rays of the space at a time of generating the captured image.

4. The information output apparatus according to any one of supplementary notes 1 to 3, wherein

the determination means determines a radius of a circle to be displayed over the captured image in an overlapping manner for the each detected person, based on a state of each of the detected persons at a time of generating the captured image.

5. The information output apparatus according to supplementary note 4, wherein

the determination means determines a radius of a circle to be displayed over the captured image in an overlapping manner, based on a height of the detected person determined based on the captured image.

6. The information output apparatus according to supplementary note 4 or 5, wherein

the determination means determines a radius of a circle to be displayed over the captured image in an overlapping manner, based on presence or absence of a disease of the detected person determined based on the captured image.

7. The information output apparatus according to any one of supplementary notes 4 to 6, wherein

the determination means determines a radius of a circle to be displayed over the captured image in an overlapping manner, based on an age of the detected person determined based on the captured image.

8. The information output apparatus according to any one of supplementary notes 4 to 6, wherein

the determination means determines a radius of a circle to be displayed over the captured image in an overlapping manner, based on a body temperature of the detected person determined based on a thermal image generated by an infrared camera.

9. An information output method including:

by a computer,

acquiring a captured image acquired by photographing a space;

detecting a person from the captured image;

determining a radius of a circle to be displayed over the captured image in an overlapping manner according to a predetermined condition; and

displaying an image in which a circle surrounding each of the detected persons is displayed over the captured image in an overlapping manner.

10. A program causing a computer to function as:

an acquisition means for acquiring a captured image acquired by photographing a space;

a detection means for detecting a person from the captured image;

a determination means for determining a radius of a circle to be displayed over the captured image in an overlapping manner according to a predetermined condition; and

a display control means for displaying an image in which a circle surrounding each of the detected persons is displayed over the captured image in an overlapping manner.

### REFERENCE SIGNS LIST

10 Information output apparatus
11 Acquisition unit
12 Detection unit
13 Determination unit
14 Generation unit
15 Display control unit
20 Imaging apparatus
1A Processor
2A Memory
3A Input/output I/F
4A Peripheral circuit
5A Bus

What is claimed is:

1. An information output apparatus comprising:
at least one memory configured to store one or more instructions; and
at least one processor configured to execute the one or more instructions to:
acquire a captured image acquired by photographing a space;
detect a person from the captured image;
determine a radius of a circle to be displayed over the captured image in an overlapping manner according to a predetermined condition; and
display an image in which a circle surrounding each of the detected persons is displayed over the captured image in an overlapping manner.

2. The information output apparatus according to claim 1, wherein
the processor is further configured to execute the one or more instructions to determine a radius of a circle to be displayed over the captured image in an overlapping manner, based on a state of the space at a time of generating the captured image.

3. The information output apparatus according to claim 2, wherein
the processor is further configured to execute the one or more instructions to determine a radius of a circle to be displayed over the captured image in an overlapping manner, based on at least one of a temperature, humidity, and an amount of ultraviolet rays of the space at a time of generating the captured image.

4. The information output apparatus according to claim 1, wherein
the processor is further configured to execute the one or more instructions to determine a radius of a circle to be displayed over the captured image in an overlapping manner for the each detected person, based on a state of each of the detected persons at a time of generating the captured image.

5. The information output apparatus according to claim 4, wherein
the processor is further configured to execute the one or more instructions to determine a radius of a circle to be displayed over the captured image in an overlapping manner, based on a height of the detected person determined based on the captured image.

6. The information output apparatus according to claim 4, wherein
the processor is further configured to execute the one or more instructions to determine a radius of a circle to be displayed over the captured image in an overlapping manner, based on presence or absence of a disease of the detected person determined based on the captured image.

7. The information output apparatus according to claim 4, wherein
the processor is further configured to execute the one or more instructions to determine a radius of a circle to be displayed over the captured image in an overlapping manner, based on an age of the detected person determined based on the captured image.

8. The information output apparatus according to claim 4, wherein
the processor is further configured to execute the one or more instructions to determine a radius of a circle to be displayed over the captured image in an overlapping manner, based on a body temperature of the detected person determined based on a thermal image generated by an infrared camera.

9. An information output method comprising:
by a computer,
acquiring a captured image acquired by photographing a space;
detecting a person from the captured image;
determining a radius of a circle to be displayed over the captured image in an overlapping manner according to a predetermined condition; and
displaying an image in which a circle surrounding each of the detected persons is displayed over the captured image in an overlapping manner.

10. A non-transitory storage medium storing a program causing a computer to:
acquire a captured image acquired by photographing a space;
detect a person from the captured image;
determine a radius of a circle to be displayed over the captured image in an overlapping manner according to a predetermined condition; and
display an image in which a circle surrounding each of the detected persons is displayed over the captured image in an overlapping manner.

11. The information output method according to claim 9, wherein
the computer determines a radius of a circle to be displayed over the captured image in an overlapping manner, based on a state of the space at a time of generating the captured image.

12. The information output method according to claim 9, wherein
the computer determines a radius of a circle to be displayed over the captured image in an overlapping manner, based on at least one of a temperature, humidity, and an amount of ultraviolet rays of the space at a time of generating the captured image.

13. The information output method according to claim 9, wherein
the computer determines a radius of a circle to be displayed over the captured image in an overlapping manner for the each detected person, based on a state of each of the detected persons at a time of generating the captured image.

14. The information output method according to claim 9, wherein
the computer determines a radius of a circle to be displayed over the captured image in an overlapping manner, based on a height of the detected person determined based on the captured image.

15. The information output method according to claim 9, wherein
the computer determines a radius of a circle to be displayed over the captured image in an overlapping manner, based on presence or absence of a disease of the detected person determined based on the captured image.

16. The information output method according to claim 9, wherein
the computer determines a radius of a circle to be displayed over the captured image in an overlapping manner, based on an age of the detected person determined based on the captured image.

17. The information output method according to claim 9, wherein
the computer determines a radius of a circle to be displayed over the captured image in an overlapping manner, based on a body temperature of the detected person determined based on a thermal image generated by an infrared camera.

18. The non-transitory storage medium according to claim 10, wherein
the computer determines a radius of a circle to be displayed over the captured image in an overlapping manner, based on a state of the space at a time of generating the captured image.

19. The non-transitory storage medium according to claim 10, wherein
the computer determines a radius of a circle to be displayed over the captured image in an overlapping manner, based on at least one of a temperature, humidity, and an amount of ultraviolet rays of the space at a time of generating the captured image.

20. The non-transitory storage medium according to claim 10, wherein
the computer determines a radius of a circle to be displayed over the captured image in an overlapping manner for the each detected person, based on a state of each of the detected persons at a time of generating the captured image.
